(19) United States
(12) Patent Application Publication
(10) Pub. No.: US 2025/0322456 A1
(43) Pub. Date: Oct. 16, 2025

(54) TRADE FINANCE DOCUMENT MANAGEMENT

(71) Applicant: SURECOMP DEVELOPMENT LTD, Kfar Saba (IL)

(72) Inventor: Enno-Burghard Weitzel, Husum (DE)

(21) Appl. No.: 18/865,363

(22) PCT Filed: May 17, 2023
(86) PCT No.: PCT/IL2023/050507

§ 371 Date: Nov. 13, 2024

Related U.S. Application Data
(60) Provisional application No. 63/342,665, filed on May 17, 2022.

(51) Int. Cl. G06Q 40/04; G06Q 10/0637; G06Q 10/10; G06Q 50/18

(52) U.S. Cl. CPC G06Q 40/04; G06Q 10/0637; G06Q 10/103; G06Q 50/188

(57) ABSTRACT

A system, for facilitating production of trade finance (TF) documents that support trade finance agreements (TFAs) and the financial instruments that implement the agreements.

### RELATED APPLICATION

This application claims benefit under 35 U.S.C. 119(e) of U.S. Provisional Application 63/342,665 filed May 17, 2022, the disclosures of which are incorporated herein by reference.

### FIELD

Embodiments of the disclosure relate to providing a system for managing and facilitating production of documents that support trade transactions and finance agreements.

### BACKGROUND

Trade finance (TF) refers to the management and provision of funding in the form of various financial instruments and products, such as by way of example importer/exporter lines of credit, letters of credit, factoring agreements, and various types of insurance, to support international trade transactions. Trade finance agreements (TFAs) to provide funding for the transactions are defined by documents that not only record and witness the histories of the processes involved in reaching the agreements but are the tools that are used to forge and implement the agreements in the various financial instruments and products, hereinafter referred to generically as financial instruments, “TFA instruments”, or simply “instruments”. Typically, the documents are complex and burdened with a web of legacy and immediate legal and financial constraints that may be dependent on national law and procedures. The documents require cooperative effort and contributions from employees belonging to different enterprises and financial institutions, optionally referred to generically as business entities, exercising trained skill sets to accomplish the various tasks needed to produce the documents.

By way of example, a process of generating a financial instrument such as a letter of credit (LC) for implementing a trade finance agreement between an importer in one country and exporter in another country involves negotiations and collaboration between employees of the importer, exporter, an issuing bank (ISS), and an advising bank. In addition, depending on various contingencies and levels of trust between the parties to the LC, generating the LC may also require cooperation of a confirming bank, a negotiating bank, and a reimbursing bank, participating in the process as separate financial institutions. The communications between the people engaged in generating the LC typically involves back and forth networking by email and messaging services, and repeated double checking and confirming terms and conditions that configure the LC. Assuming that anywhere from about 3 to 5 employees of each enterprise and financial institution are involved in generating the LC, the person hours invested in the communications represent a relatively significant management overhead to consummating the agreements.

### SUMMARY

An aspect of an embodiment of the disclosure relates to providing a system, hereinafter also referred to as a TF-Facilitator, for managing and facilitating production of trade finance agreement, TFA, documents that support TFAs and the financial instruments that implement the agreements. The TF-Facilitator may comprise an, optionally cloud based, data and processing hub, having a suite of functionalities that includes a status and navigation dashboard, optionally referred to as “DashStat”, a real-time collaborative form-filling application, optionally referred to as “FilForm”, and a real-time collaborative chat application, optionally referred to as “RealChat”. The hub comprises and/or has access to software and hardware resources, including a memory and processor for storing and processing data and/or executable code, generically referred to as software, for supporting operations of the suite of functionalities.

DashStat interfaces a user with TF-Facilitator and enables the user to access given TFAs managed by TF-Facilitator to select and access data associated with the given TFAs for viewing, updating, and/or amending, and/or engaging in activities associated with the given TFAs. FilForm enables the user, on his or her own, and/or in collaboration with at least one other user, to engage in filling out TFA forms that may be required to be filled out to complete TFA documents that support and implement the given TFAs. RealChat enables users to message and communicate with each other by text and/or voice to collaborate in filling out TFA forms and engage, optionally real time, in negotiation chats to determine agreed upon data to be filled into the TFA forms.

In an embodiment the TF-Facilitator hub maintains a TFA database in the memory comprising for each of a plurality of different types of TFAs a set of TFA forms that may be required to be filled out to generate TFA documents required by the TFAs. Upon a user initiating a new TFA of a particular type to be managed with the aid of TF-Facilitator, the TF-Facilitator hub cooperates with the user to open a file for the TFA in the hub memory and initializes the TFA file with a set of TFA forms that provide a roadmap of forms to be filled out for successfully completing the TFA.

Optionally, for each of the TFA forms the hub and/or an authorized user may initialize the TFA file with a roster of enterprises, financial institutions, and/or their respective employees, optionally referenced generically as collaborators, to collaborate with to fill out the TFA forms. Optionally, each collaborator in the roster is associated with at least one TFA form for which the collaborator may be necessarily or advisedly required to cooperate with in bringing the TFA form to completion. A group of collaborators associated with a same TFA form may be referred to as a collaboration network, or simply network, of the form. During processing of the TFA, authorized users may update TFA form networks to include new members or delete current members.

When a user accesses the TF-Facilitator hub to use FilForm and/or RealChat to process a TFA form, the hub may alert the user to a member or members of the TFA form's collaboration network available for collaborating in processing the form. In an embodiment the hub processes FilForm and RealChat sessions engaged in by an authorized user or users to acquire and use data relevant to maintaining the TFA forms current. Optionally, the hub stores TFA records of the sessions comprising complete or filtered copies of the sessions and/or selected data filtered or otherwise processed from the sessions in a hub memory.

In an embodiment, the hub processes procedural histories for the TFAs based on the TFA records to determine features that distinguish the histories responsive to values for at least one or any combination of more than one key performance indicator (KPI) from a set of TFA KPIs that the hub generates for the histories. A TFA KPI may be relevant to the process of completing the TFA as a whole or to a given component such as a stage or TFA form of the TFA process, also optionally referred to as a TFA project. By way of example, KPIs for a TFA may comprise a length of time elapsed in processing the TFA and/or individual TFA forms to completion, a measure of human resources, for example as determined by person hours, optionally weighted by personnel rank or skill set, invested in processing the TFA, and/or a measure of communications, such as bandwidth consumed in processing the TFA or a stage of the TFA. Optionally, the KPIs are weighted by functions of an amount of funding and risk factors associated with the TFA.

In an embodiment, the hub uses a classifier to distinguish and classify a TFA process in accordance with a figure of merit based on one or more of the TFA KPIs that indicates a degree to which the TFA process is considered to be a successful or meritorious process uscable as an instructional model to improve configuration and management of the TFA process. Optionally, the classifier is an artificial intelligence (AI), such as a deep neural network (DNN). In an embodiment the hub extracts features from an optionally hidden feature layer of the DNN to identify features that distinguish meritorious TFA processes. In an embodiment, the hub processes the distinguishing features to determine which personnel skill sets are advantageously made available to a given stage of a TFA process to contribute to making the TFA process meritorious.

In an embodiment, DashStat comprises a TF landing and navigation page, optionally referred to as a TF home page, that TF-Facilitator presents to a user when the user first accesses TF-Facilitator. The home page displays a graphical user interface (GUI) that provides the user with a summary view of TFA deals that are engaged in by the user's business entity and the user. The home page displays an array of selection icons, “radio buttons”, that may be clicked on to navigate the display to information for different desired segments of data that TF-Facilitator comprises for the business entity's TFA deals to enable the user to view and/or interact with the information.

In an embodiment of the disclosure the radio buttons displayed in the home page comprise a plurality of TFA ID cards. A TFA ID card represents a TFA file that was opened for a TFA deal in TF-Facilitator and exhibits a set of values for characterizing features, optionally referred to as TFA ID features, that may be used to identify the TFA deal. Clicking on a particular ID card navigates the home page to an image, optionally referred to as a gateway image of the ID card that includes a navigation menu comprising various selectable menu entries that enable the user to access and view and/or modify different types of data in the TFA file. Optionally, the menu comprises a menu entry, which when clicked on morphs the display to an action display for the TFA file. The action display may show a set of open action items that have yet to be addressed, optionally represented by a set of stacked action index cards ordered by priority of the action items. When a user selects a given action index card, the index card identifies a corresponding action item that prompts and enables the user to undertake appropriate action to address the action item.

The action display may also exhibit a TFA summary panel that optionally displays summary data for the TFA deal and provides an option for toggling the panel to a RealChat chat panel in accordance with an embodiment of the disclosure. When a user selects an action index card associated with a particular action item, such as filling out a form, and opts to morph the TFA summary panel to the RealChat panel, RealChat accesses the TFA file to identify collaborators in a collaboration network associated with particular action item. RealChat presents the identified collaborators to the user so that the user may select a collaborator or collaborators from the network to communicate with via RealChat to cooperate in addressing the action item and/or to notify that the action item is being addressed.

Optionally the home page displays a header banner displaying a row of annular, “wheel”, radio buttons segmented into sectors that may be distinguished by color. Each wheel button represents a different particular TFA ID feature and displays at a center of the wheel a total number of different values that the particular ID feature assumes for the business entity's TFA deals. Each colored sector represents a different given value that the particular ID feature assumes. An angular extent of the colored sector graphically represents a portion of the enterprise TFA deals for which the particular TFA ID feature exhibits the given value. Clicking on a given colored sector filters the ID cards displayed on the home page to display only those ID cards that are distinguished by the particular TFA ID value.

Optionally the home page displays a responsibility alert radio button (RABUT) that exhibits a number of pending TFA deals for which the user has responsibility. Clicking on the RABUT filters the ID cards displayed on the home page to only those ID cards for which the user has responsibility.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

Non-limiting examples of embodiments of the disclosure are described below with reference to figures attached hereto that are listed following this paragraph. Identical structures, elements or parts that appear in more than one figure are generally labeled with a same numeral in all the figures in which they appear. A label labeling an icon representing a given feature in a figure of an embodiment of the disclosure may be used to reference the given feature. Dimensions of components and features shown in the figures are chosen for convenience and clarity of presentation and are not necessarily shown to scale.

FIG. 1 schematically illustrates a pattern of communications that may characterize a process of generating TFA documents to provide a letter of credit (LOC) for a TFA supporting a trade transaction, in accordance with prior art;

FIG. 2 schematically shows a pattern of communications that may characterize using a TF-Facilitator to implement the LOC of the TFA illustrated in FIG. 1, in accordance with an embodiment of the disclosure;

FIGS. 3A and 3B show a flow diagram illustrating use scenario of a TF-Facilitator to implement a TFA, in accordance with an embodiment of the disclosure;

FIG. 4A shows a screenshot of a TF-Facilitator DashStat home page, in accordance with an embodiment of the disclosure;

FIG. 4B shows a screenshot of the DashStat home page after a user has clicked on a RABUT radio button in the home page to filter the home page to display TFA ID cards only for TFAs for which the user has responsibility, in accordance with an embodiment of the disclosure;

FIG. 4C shows a screenshot of the DashStat display after the user has clicked on a particular ID card displayed in FIG. 4B, in accordance with an embodiment of the disclosure;

FIG. 4D shows a screenshot of the DashStat display after the user has clicked on an icon in the ID card displayed in FIG. 4C to access an action display for the TFA identified in the ID card, in accordance with an embodiment of the disclosure; and

FIG. 4E shows a screenshot of the DashStat display after the user has opted to morph the action panel in the action display of FIG. 4C to a RealChat panel, in accordance with an embodiment of the disclosure.

### DETAILED DESCRIPTION

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment in an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily required, configuration of possible embodiments of the disclosure. Each of the verbs, “comprise” “include” and “have”, and conjugates thereof, are used to indicate that the object or objects of the verb are not necessarily a complete listing of components, elements or parts of the subject or subjects of the verb. Unless otherwise indicated, the word “or” in the description and claims is considered to be the inclusive “or” rather than the exclusive or, and indicates at least one of, or any combination of more than one of items it conjoins.

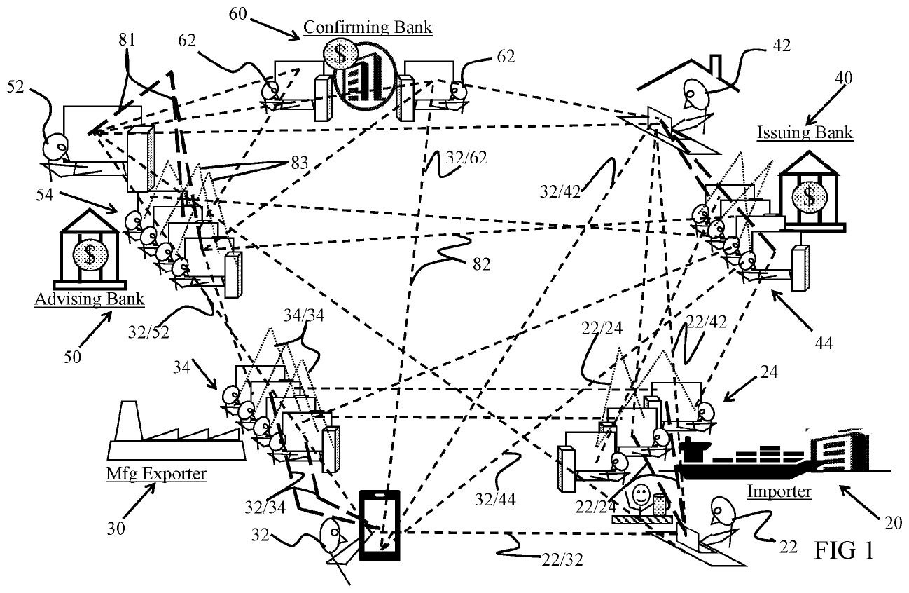

FIG. 1 schematically illustrates a pattern of communications and activities between personnel of various enterprises and financial institutions engaged in a hypothetical scenario to provide an irrevocable letter of credit (ILOC) for a trade finance agreement (TFA) supporting a trade transaction, in accordance with prior art.

The trade transaction is assumed to be an import/export transaction in which an importing enterprise, an importer 20, is interested in purchasing and importing goods manufactured by an exporting manufacturing enterprise, a manufacturer 30. To manufacture and provide the goods, manufacturer 30 requires an ILOC issued to the benefit of the manufacturer that is payable upon shipping of the goods. Importer 20 arranges to have the required ILOC issued by an issuing bank 40 to the benefit of manufacturer 30 payable upon submission by the manufacturer of appropriate shipping documents to an advising bank 50. Payment is guaranteed by a confirming bank 60.

Importer 20 employs a senior executive 22 and personnel 24. Manufacturer 30 employs a senior executive 32 and personnel 34. Banks 40 and 50 respectively employ senior banking executives 42 and 52. Bank executives 42 and 52 are responsible for managing employees 44 and 54 of their respective banks. Confirming bank 60 employs personnel 62. Enterprises 20 and 30 and banks 40, 50, and 60 are generically referred to as business entities.

In the figure the pattern of communications associated with the trade transaction, TFA, and the ILOC comprises a thicket of internal communications between personnel of a same business entity, and external communications between personnel of any two or more of the business entities. Bold dashed lines 81 characterized by long dashes represent communications between executives and employees in a same business entity 20, 30, 40, 50 or 60. Dashed lines 82 characterized by medium length dashes represent external communications—communications between personnel of any two or more of the business entities. Fine dotted lines 83 represent internal communications between personnel of a same business entity. A particular communication or group of communications may be referred to by a distinguishing numeral labeling a communication line representing the communication/s.

The trade transaction for the purchase of goods from manufacturer 30 by importer 20 is assumed initiated by communications represented by a line 22/32 between senior executive 32 using a mobile phone and senior executive 22 working from a coffee shop. The communications between executive 32 and importing executive 22 set off a cascade of activities and associated communications 81 and 83 between employees of a same business entity and external communications 82 between employees of different business entities. The activities involve employees of each of the business entities checking and double checking the same terms and conditions of the trade transaction and exchanging between themselves and with employees of the other business entities, the documents and forms that support the TFA and ILOC.

For example, upon agreement between executives 22 and 32 on the proposed purchase of goods that define the trade transaction and terms for an ILOC, in a communication 22/42, executive 22 alerts bank manager 42, who is shown working from home, to a need to issue an ILOC to support the trade agreement. Executive 22, bank manager 42, and an employee of confirming bank 60 discuss collateral that manufacture 20 can provide to guarantee the ILOC. In a communications 22/24 executive 22 tasks personnel 24 with, for example, reviewing and vetting the proposed purchase and terms, and checking relevant inventories. In response, personnel 24 engage in a series of internal communications 24/24 to carry out the tasks. Similarly, manufacturing executive 32 is assumed to alert personnel 34 in communications 32/34 to review and vet the proposed ILOC terms, check relevant inventory, raw materials, and supply chains. Following communications 32/34 personnel 34 engage in a series of internal communications 34/34 associated with the alerted tasks. Manufacturing executive 32 presumably discusses the TFA and ILOC with advising bank executive 52 in a communication 32/52 and with a confirming bank employee 62 in a communication 32/62. Manufacturing executive 32 discusses the TFA and ILOC with the executive and an employee of the issuing bank 40 in communications 32/42 and 32/44 respectively.

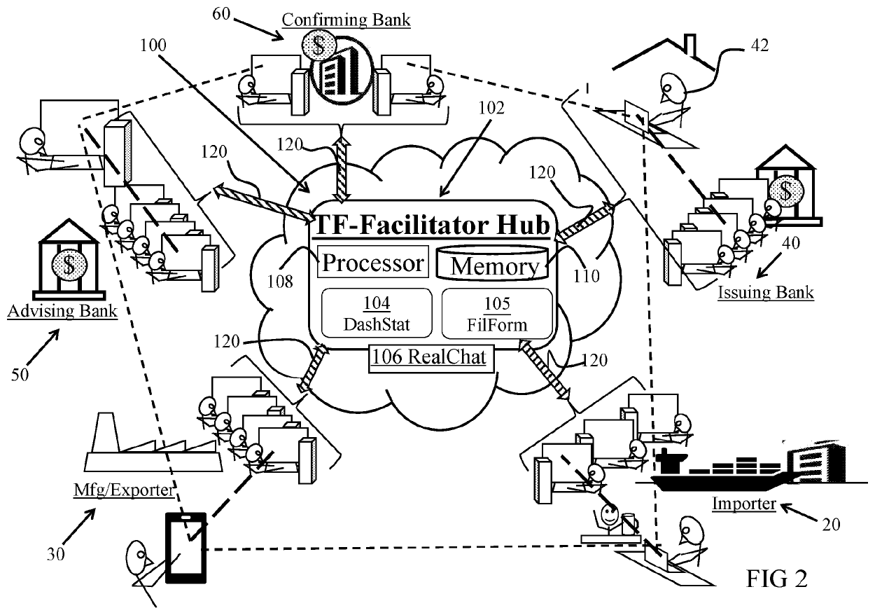

FIG. 2 schematically shows personnel of business entities 20, 30, 40, 50, or 60 shown in FIG. 1 using a TF-Facilitator 100 to support and provide a TFA and ILOC in accordance with an embodiment of the disclosure for the same import/export trade transaction between importer 20 and manufacturer 30 described above with reference to FIG. 1.

TF-Facilitator 100 comprises an optionally cloud based TF-Facilitator hub 102 having DashStat 104, FilForm 105, and RealChat 106 applications, available to subscribers of TF-Facilitator 100 optionally as software as a service (SaaS) applications. TF-Facilitator 100 comprises and/or has access to a processor 108 and a memory 110 configured to support functionalities that TF-Facilitator 100 provides. In accordance with an embodiment, as discussed below, DashStat 104 is configured to interface a user of TF-Facilitator 100 with monitoring and management functionalities that TF-Facilitator 100 provides for a TFA process such as the process illustrated in FIG. 1. FilForm 105 is configured to support cooperative filling out TFA forms required by the process. TF-Facilitator 100 enables business entities 20, 30, 40, 50, or 60 to carry out the process illustrated in FIG. 1 of realizing a TFA and ILOC with improved efficiency and substantial reduction in the communications overhead associated with the process. Activities and communications represented by and/or associated with the thicket of communications shown in FIG. 1 are replaced by TF-Facilitator communications and interactions with TF-Facilitator hub 102 schematically represented in FIG. 2 by patterned block arrows 120.

In an embodiment, memory 110 comprises a TFA-Database having data characterizing a plurality of different TFA types, TFAᵢ (1≤i≤I), and for each TFAᵢ optionally a set of stages st_{i,j} (1≤j≤J(i)) into which the TFAᵢ process for providing an associated at least one TFAᵢ financial instrument may be segmented. In an embodiment the data for a TFAᵢ includes TFA forms to be filled out and documents that have to be addressed, collected, and/or processed to complete stages of the TFAᵢ process.

For example, for the import export scenario described with respect to FIG. 1 the TFA includes an agreement or agreements specifying, among other items, traded goods to be exported and imported, packaging, shipping endpoints and scheduling, insurance, and terms of payment provided by a TFAᵢ financial instrument that is an ILOC. Stages into which the TFAᵢ process supporting the TFA may be parsed includes: an initial negotiating stage between importer 20 and exporter 30 to establish a “pro-forma” purchase order for the traded goods and a second stage in which specification of the traded goods and terms of the proforma are vetted and checked by personnel 22 and 24 of importer 20 and personnel 32 and 34 of exporter 30. Other stages that may be defined by way of example for the process include: a stage in which personnel of importer 20 and issuing bank 40 negotiate and vet a preliminary draft of the ILOC; a stage in which personnel of advising bank 50 review, discuss with personnel of exporter 30, and vet the preliminary ILOC draft; a stage in which personnel of business entities 20, 30, 40, 50, and 60 negotiate guarantees provided by confirming bank 60; and a final stage in which personnel of possibly all the business entities perform a review of the draft ILOC, documents relevant to the ILOC, and the ILOC is issued and copies of the issued ILOC are distributed to the business entities.

It is noted that the various stages of a TFAᵢ process, such as that described above, are not necessarily sequential, may occur in different temporal orders, and various stages may overlap in time and/or be separated by time periods of various duration. Stages for a given TFAᵢ process may not be sharply demarcated one from the other by bright line boundaries. Stages may share same tasks and/or elements of same tasks and personnel that engage in the tasks.

In accordance with an embodiment of the disclosure, a stage of a given TFAᵢ process may be defined by a stage profile that optionally includes a set of identifying features, contextual features, and key performance indicators, and/or KPIs that characterize the stage. Identifying features may comprise a distinguishing ID, an ID that identifies the TFAᵢ to which the stage belongs, and descriptive features of the stage. Descriptive features may comprise a number of different forms involved in the process that have to be filled out, a measure of the complexity of the forms, a list of the forms and for each form, fields in the form that have to be addressed and filled out to complete the stage. Contextual features may comprise a class defining a magnitude of financing involved and countries for which the forms may be particularly configured. KPIs, may comprise an average and standard deviation of a period of time required to complete the stage, an average and standard deviation of a period of time required to fill out each form in the list of forms cited in the descriptive features for the stage, an average and standard deviation for a number of person hours, optionally weighted by person rank and/or skill set, required to complete the stage, and/or a measure of communications bandwidth consumed in processing the stage. KPIs for a TFAᵢ process may be determined as functions of KPIs for the stages into which the TFAᵢ process is parsed.

Features defining a TFAᵢ process stage may be interdependent. For example an average time to completion of a TF stage is expected to be a function of a number and complexity of forms that are required to be filled out to complete the stage. The time is also expected to be dependent on a number of persons who may be working substantially simultaneously to complete the TFAᵢ stage and/or on skill sets and seniority that the persons bring to execution of the stage.

In an embodiment, TF-Facilitator 100 may process histories of a plurality of TFA processes for a given trade finance type, TFAᵢ, to determine interdependence of components of the stage profile for a given stage of the TFAᵢ. For example TF-Facilitator 100 may process the histories to determine how a completion time of the given stage depends on the seniority and/or skill sets of the persons that are assigned to carry out the stage. Optionally, TF-Facilitator 100 uses a neural network to determine the dependencies. For example, a neural network trained to classify examples of execution of a given stage of a TFAᵢ process according to how meritorious the execution is considered to be, may be used to classify examples of execution of the stage by different groups of personnel. The groups may be selected so that different groups include different numbers of people and/or different groups include people having different seniorities and/or skill sets or different numbers of people having a same seniority and/or skill set. Classification of the executions may be used to determine a degree to which execution of the stage is considered to be satisfactory as a function of a number, skill sets, and/or seniorities of the people carrying out the stage. Classification of the executions may be used to provide guidelines for determining members of TFA form networks for forms to be filled out during the stage.

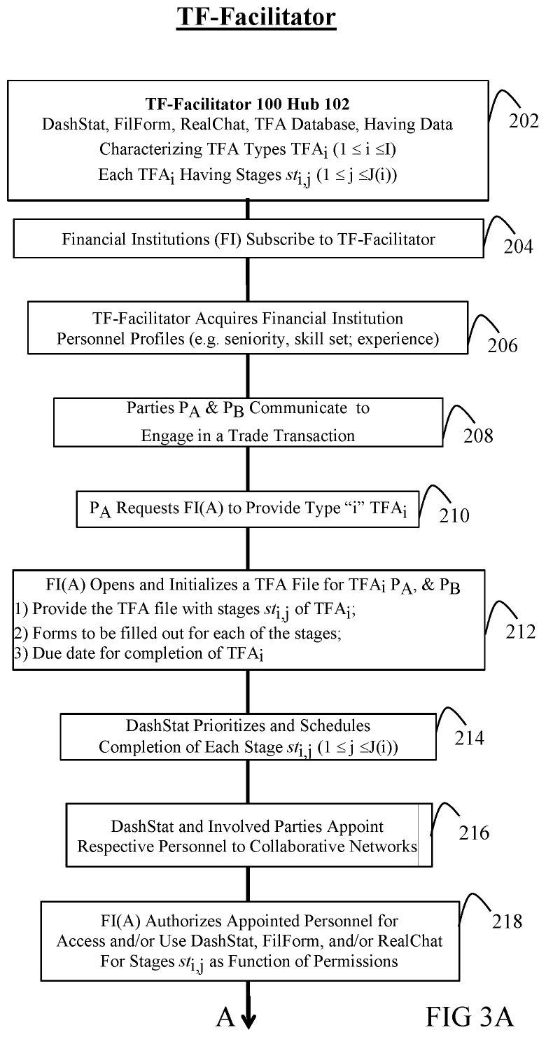

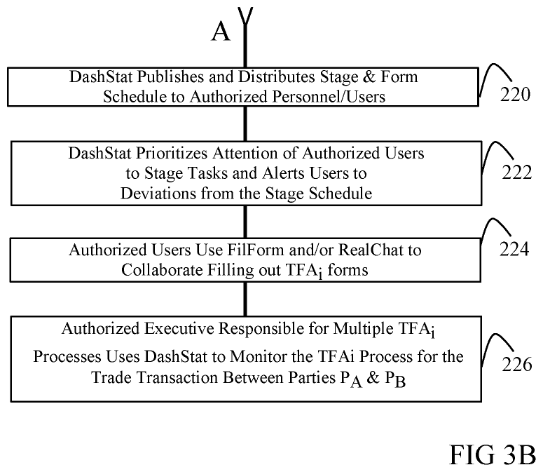

FIGS. 3A and 3B show a schematic flow diagram 200 illustrating an example scenario as to use of TF-Facilitator 100, to facilitate a TFA process in accordance with an embodiment of the disclosure. Optionally, as listed in a block 202, TF-Facilitator 100 comprises a hub 102 having a DashStat, FilForm, and RealChat (FIG. 2) that are optionally SaaS applications. The hub comprises a TFA Database having data characterizing TFA types TFAᵢ (1≤I≤I) each TFAᵢ having stages st_{i,j} (1≤j≤J(i)). In a block 204 various financial institutions (FIs) subscribe to TF-Facilitator 100. Optionally in a block 206 the TF-Facilitator for each FI subscribed to TF-Facilitator 100, the TF-Facilitator acquires profiles of FI personnel, hereinafter also referred to as users, that may be authorized by the FI to use services that the TF-Facilitator provides. The profile of an FI user may comprise information defining the user's skill sets, TFA types for which the user has experience, and seniority or rank at the FI.

In a block 208 enterprise parties P_{A} and P_{B} communicate with each other to initiate a trade transaction between them and in a block 210 party P_{A} requests a financial institute FI(A) subscribed to TF-Facilitator to provide trade finance of a given type TFAᵢ to facilitate the trade transaction. The request may comprise an amount of financing that TFAᵢ is requested to provide and a desired date or dates by when the financing is to be provided. In response to the request from party P_{A}, optionally in a block 212, FI(A) accesses DashStat in hub 102 to open and initialize a TFA file for the TFAᵢ requested by P_{A}. Initializing may comprise provisioning the file with stages st_{i,j} (of TFAᵢ) to be completed to successfully implement TFAᵢ, forms to be filled out for each of the stages, and a TFA due date for completing TFAᵢ. Optionally in a block 214, based on the desired TFA due date, and initialization of stages st_{i,j} and forms, DashStat, and/or other software in TF-Facilitator, hereinafter for convenience of presentation referred to as DashStat prioritizes and schedules performance of the stages, forms, and documents that have to be addressed to complete TFAᵢ on time.

Scheduling may comprise determining advantageous completion times for forms to be filled out for each stage st_{i,j} and for each of the forms an initial collaboration network of business entities and personnel to be tasked with completion of the forms. In an embodiment, advantageous completion times and members of suggested collaboration networks may be determined based on data in the TF-Database for average and standard deviations of completion times of stages st_{i,j} as functions of the numbers, skill sets, and seniorities of personnel tasked with completing the states. The tasked personnel may be drawn from parties and financial institutes involved with the TFAᵢ. The involved parties include party P_{A}, party P_{B}, financial institute FI(A), possibly an advising financial institute FI(B) associated with party P_{B} and other enterprises, financial institutes, and/or individuals and that are stakeholders in the trade transaction and/or TFAᵢ process.

In a block 216 the involved parties appoint respective personnel to engage in executing the various tasks required to complete the TFAᵢ process and assign the appointees with appropriate selective permissions for access to TF-Facilitator 100 and material generated by the TFAᵢ process. In a block 218, optionally FI(A) provides appointed personnel, also referred to as authorized users, with authorizations in accordance with their respective permissions to access functionalities provided by hub 102 and use DashStat 104, FilForm 105, and/or RealChat 106 to carry out tasks to be performed for the stages and associated forms to which they were respectively appointed.

In a block 220 (FIG. 3B) DashStat publishes and makes the schedule for completing stages st_{i,j} of the TFAᵢ process via a TF-Facilitator GUI home page that authorized users land on when they first open TF-Facilitator. Via the home page optionally in a block 222 DashStat prioritizes attention of authorized users to tasks of the stages that are to be performed and alerts the uses to deviations from the stage schedule. The home page provides the user with graphical attention indicators and an assortment of radio buttons to indicate tasks and/or stages that need the user's attention and/or contribution and optionally enable the user to select from an overview of progress of the TFAᵢ process particular stages and associated forms of the process for review and analysis. Stages and forms may be selected for review responsive to any of the features listed in a stage profile.

Optionally in a block 224 authorized users use FilForm and/or RealChat to collaborate in addressing documents and filling out forms that are required by TFAᵢ process stages st_{i,j}.

Optionally in a block 226 an authorized senior executive (not shown) of financial institute FI(A) who is responsible for multiple trade transactions and associated TFAᵢ processes, including the TFAᵢ processes between party P_{A} party P_{B}, uses DashStat 104 to review the status of different TFAᵢ processes for which she is responsible. To perform the review, she opens DashStat 104 to the TF-Facilitator home page displaying attention indicators that alert her attention to TFAᵢ files that demand urgent attention, and a selection panel that enables her to select TFAᵢ files according to any of various statistical and/or keyword data fields. Upon opening DashStat 104 DashStat displays an attention indicator for the TFAᵢ process between party P_{A} party P_{B} that alerts her to an anomalous delay in progress of the TFᵢ process.

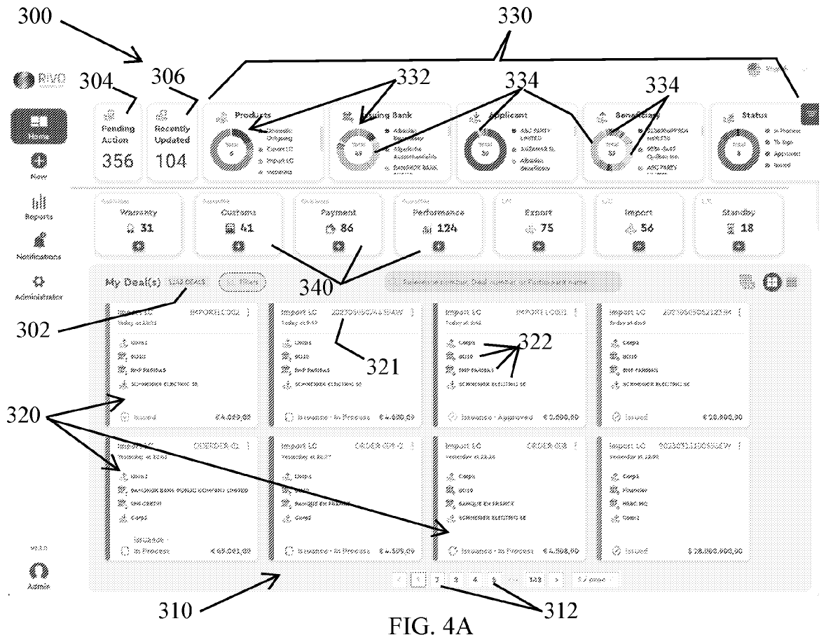

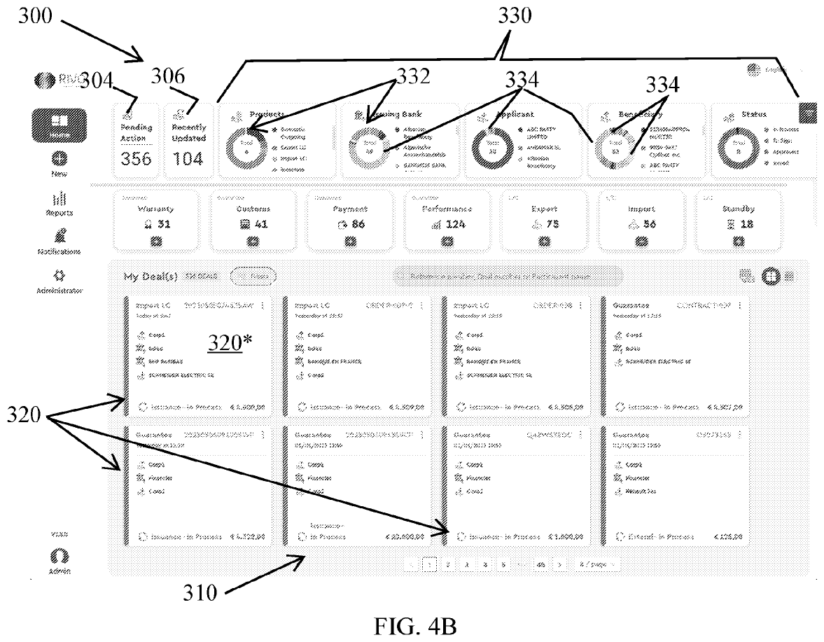

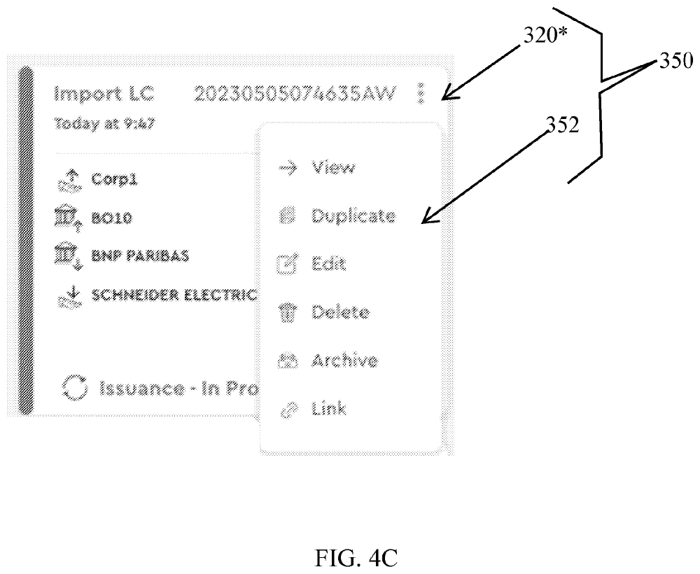

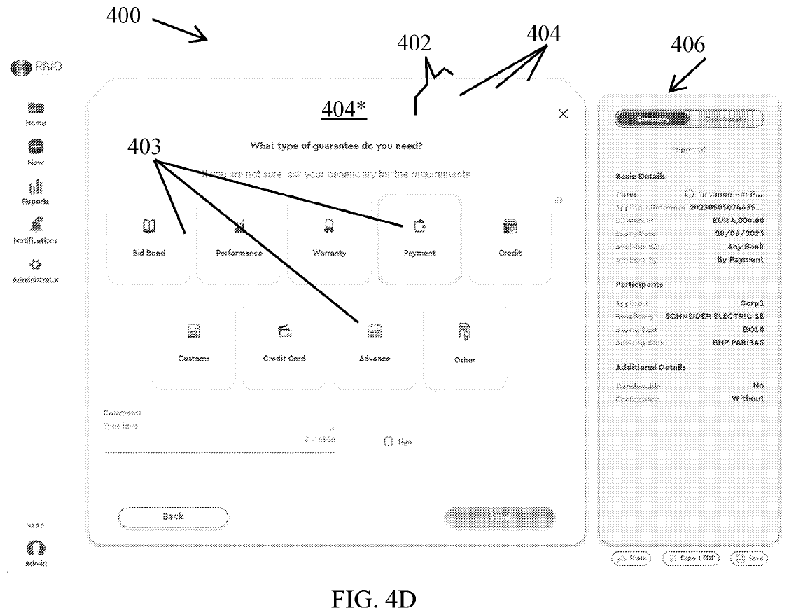

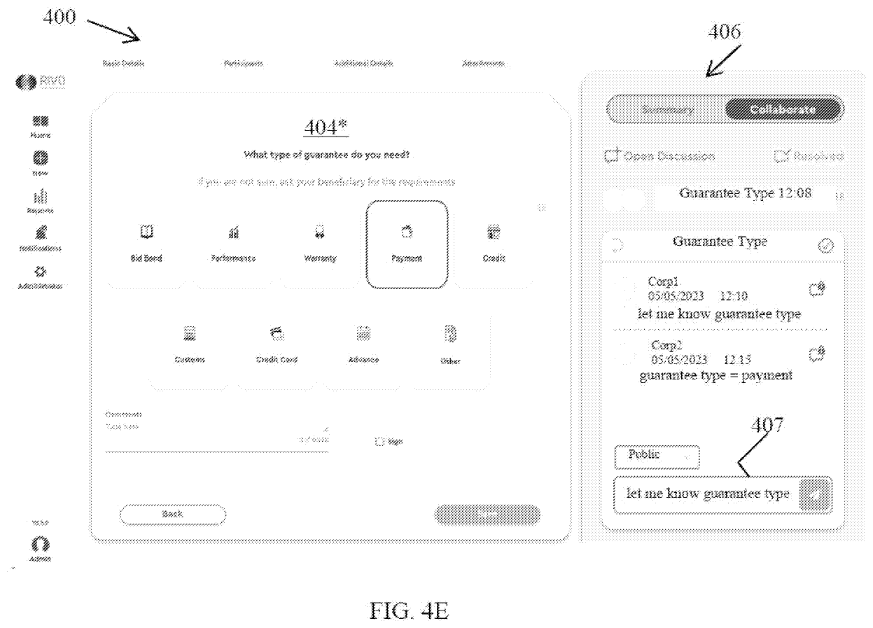

FIGS. 4A-4E show screen shot displays and a selection of features of the displays generated by DashStat 104 (FIG. 2) in response to a user interfacing with TF-Facilitator 100 (FIG. 2) to interact with a TFA file in accordance with an embodiment of the disclosure.

FIG. 4A shows a screen shot of a TF-Facilitator home page 300 in accordance with an embodiment of the disclosure that DashStat 104 exhibits for a user on a user display screen upon the user accessing the TF-Facilitator. The user is assumed to be an employee of a corporation, referred to as Corp1 that manages a large number of TFAs, with the assistance of the TF-Facilitator in accordance with an embodiment of the disclosure.

At a lower portion of home page 300 DashStat 104 exhibits a first TFA ID card panel 310 of a plurality of TFA ID card panels 310 each showing a plurality of, optionally 8, TFA ID cards 320. A TFA ID card 320 represents a TFA file for a TFA project, also referred to as a deal, managed by Corp1 with the aid of TF-Facilitator 100 and optionally exhibits TFA ID serial number 321 and set of values 322 for characterizing TFA ID features that may be used to identify the TFA deal. Additional TFA ID card panels 310 may be accessed by clicking on page number icons 312 at the bottom of the ID card panel. A total number of Corp1 TFA deals is optionally shown in an information cell 302 over a left hand upper corner of ID card panel 310. Information cell 302 shows by way of example that Corp1 is managing or has managed a total of 1142 deals with the assistance of TF-Facilitator.

As discussed below with reference to FIG. 4C Clicking on a particular ID card 320 navigates the home page to a gateway image of the ID card that includes a menu comprising various selectable menu entries that enable the user to access, view, and/or modify different types of data in the TFA file.

Optionally at the top of home page 300 DashStat 104 displays a responsibility alert radio button, RABUT 304, that alerts the user to a total number of TFAs for which of the total number of TFAs that Corp1 currently manages, the user is responsible. RABUT 304 shows that the user is responsible for 356 TFA files. Optionally, adjacent RABUT 304 is an information alert button 306 that informs the user of a number of the users files that have recently been updated. RABUT 304 shows that the user is responsible for 356 TFA of Corp1's TFA files. Clicking on RABUT 304 limits the home page display of ID cards 320 to ID cards for deals for which the user has a responsibility. Clicking on information alert button 306 limits the home page display of ID cards 320 to only ID cards for deals for which the deal file has recently been updated.

In an embodiment, adjacent to information button 306, home page 300 displays a header banner 330 having wheel radio buttons 332, also referred to as wheel buttons 332 or simple wheels 332, for convenience of presentation. Each wheel 332 represents and is labeled by a different TFA ID feature that characterizes TFAs. The ID features may be used in addition to a TFA serial number 321, as a component of an identity feature vector that distinguishes and characterizes a given TFA from other TFAs that Corp1 manages. At the center of each wheel 332 is a number indicating a number of different values that the TFA ID feature represented by the wheel may assume. Each wheel button 332 is partitioned into sectors 334 each sector 334 representing a different particular value that the wheel's ID feature may assume. A size of a given sector 334 is proportional to a fraction of, optionally Corp1 TFA files, that are characterized by the particular value of the TFA ID feature that wheel 332 represents. Clicking on a given sector 334 of a wheel 332 filters the display of ID cards on the home page to only those TFA ID cards that are distinguished by the particular TFA ID value.

Optionally, as shown in FIG. 4A home page 300 shows 5 wheel radio buttons 332 for TFA ID features: Products, Issuing Bank, Applicant, Beneficiary, and Status. As shown in the centers of the wheels, a total number of different values that Products, Issuing Bank, Applicant, Beneficiary, and Status may assume for Corp1 deals are 6, 49, 30, 53 and 8 respectively.

Below wheel radio buttons 332 home page 300 may exhibit a set of additional radio buttons 340 that may be clicked on to filter TFA ID cards 320 shown in ID card panels 310 responsive to different TFA features with which the additional radio buttons 340 are associated. By way of example, additional radio buttons 340 are associated with different types of guarantees that may be relevant to TFA deals for which the user has a responsibility.

FIG. 4B shows home page 300 after the home page has been modified by the user clicking on RABUT 304, and on a sector 334 of Status wheel radio button 332 representing a TFA deal status of “In Process”.

FIG. 4C shows a gateway image 350 of TFA ID card 320 distinguished by a label 320* shown in FIG. 4B in the upper left corner of TFA ID card panel 310 for a TFA file identified inter alia by a TFA Ser. No. 20230505074635AW. Gateway image 350 was generated by TF-Facilitator responsive to the user clicking on TFA ID card 320*. In accordance with an embodiment gateway image 350 comprise an enlarged image of TFA ID card 320* optionally partially overlaid by a navigation menu 352 comprising a list of action items the user may undertake with respect to the TFA deal, also referred to as TFA deal 320*, represented by TFA ID card 320*. Optionally, one of the action items is identified by an arrow labeled with the word “View”. By clicking on action item “View” gateway image 350 may morph to an action display for TFA deal 320*.

FIG. 4D shows an example action display 400 that may be reached by clicking on the menu item labeled “View” shown in FIG. 3C, in accordance with an embodiment of the disclosure.

In an embodiment, action display 400 comprises a set 402 of stacked action index cards 404 optionally adjacent a TFA panel 406 that may be toggled between a summary mode and a collaborate mode and in FIG. 4D panel 406 is shown in summary mode displaying summary data for TFA deal 320*. Each of action index cards 404 designates an action that the user is advised to undertake to advance the TFA deal 320* to successful completion. In an embodiment designated action items are determined by FilForm 105 (FIG. 2) which keeps track of information that has to be provided to fill out forms that are required to support TFA instruments. Action index cards 404 are optionally ordered by priority of the designated action determined. Prioritizing may be accomplished automatically, optionally by FilForm 105, manually by the user or a member/s of a TFA network associated with the TFA deal, or by FilForm 105 in cooperation with the user and/or a TFA network member/s. In an embodiment, FilForm 105, prioritizes the action index cards responsive to a current state of progress of TFA deal 320*, processing records associated with histories of similar TFA deals logged into memory 110 of TF-Facilitator 100, and/or a number and qualifications of users available to undertake actions designated by the action index cards.

By way of example, in FIG. 4D a first, high priority action index card individualized by the label 404* designates an action item requiring determination of a guarantee type required by TFA deal 320* and alerts the user, who as noted above is assumed to be an employee of Corp1, to take action to determine the guarantee type. As an aid to the user the action index card 404* displays, optionally in selection buttons 403, a number of different possible guarantee options that might be appropriate.

However, determining the guarantee type is advisedly accomplished in collaboration with the TFA benefactor, who is assumed to be a corporation referred to as, Corp2, and to confer with an appropriate authorized employee/s of Corp2 to decide the guarantee type. In accordance with an embodiment of the disclosure to undertake the collaboration the user toggles panel 406 from summary mode to collaborate mode to invoke RealChat 106 (FIG. 2) and communicate with an employee of Corp2 regarding the guarantee type. When invoking RealChat 106 the user may indicate that communication with an authorized employee via RealChat is public and available for viewing by any authorized stakeholder in TFA deal 320*.

FIG. 4E shows action display 400 after the user has toggled panel 406 to collaborate mode and invoke RealChat 106. When invoked with respect to the guarantee action item RealChat may operate to automatically identify members of collaboration networks for TFA forms requiring the guarantee type. Since the Corp1 user has indicated that communications regarding the guarantee type are public, RealChat 106 may notify all members of the collaboration networks of a request for information regarding the guarantee type that the user typed into a message box 407 at the bottom of panel 406 and makes the guarantee action item index card 404* available to the members. A response by a Corp2 employee notified by RealChat of the Corp1 request is made by the Corp2 employee by return message noted in a history of the communications between Corp 1 and Corp 2 displayed in panel 406 and by framing of the Payment option selection 403 in a copy of action item index card 404*.

Descriptions of embodiments of the disclosure in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A system for facilitating production of trade finance agreements (TFAs), the system comprising:
a memory or access to a memory having:
a database comprising for each of a plurality of TFA types, a set of TFA forms comprising at least one TFA form for filling out to implement TFAs of the TFA type;
at least one value for each of at least one key performance indicator (KPIs) associated with performance in implementing the TFA type; and
a list of members of at least one collaboration network suitable for collaboration in filling out the set of TFA forms;
software executable to:
open a file for a TFA of a given TFA type of the plurality of TFA types and to use the set of TFA forms, at least one KPI, and at least one collaboration network for the TFA type to facilitate implementation of the TFA; and
automatically prioritize filling out the TFA forms of the set of TFA forms for the TFA of the given TFA type based on a value of a KPI of the at least one KPI for the given TFA type; and
a processor operable to execute the software.

2. The system according to claim 1 wherein the least one value for a KPI of the at least one KPI for a given TFA type of the plurality of TFA types is generated by the system based on processing implementation histories of a plurality of TFAs of the given type.

3. The system according to claim 2 wherein the at least one KPI comprises a KPI associated with performance in filling out a form of the set of forms for the TFA type.

4-5. (canceled)

6. The system according to claim 1 wherein the software is configured to use a classifier to determine a figure of merit for an implementation of a TFA of a TFA type of the plurality of TFA types based on one or more KPIs determined for the implementation of the TFA.

7. (canceled)

8. The system according to claim 1 wherein members of the at least one collaboration network for the TFA of the given TFA type are determined by the system based on processing implementation histories of a plurality of TFAs of the given type.

9-10. (canceled)

11. The system according to claim 8 wherein the processing comprises generating a profile of a member of the at least one collaboration network.

12-13. (canceled)

14. The system according to claim 1 wherein the software is executable to automatically initialize the file with the set of TFA forms.

15. The system according to claim 1 wherein the software is executable to provide a graphical user interface (GUI) to enable authorized users to access and interact with data in the file.

16. The system according to claim 15 wherein the software is executable to enable a plurality of authorized users to communicate with each other by text and/or voice to access and collaborate via the GUI to fill out a TFA form of the set of TFA forms.

17. The system according to claim 16 wherein the software enables the users to communicate in real-time.

18. The system according to claim 16 wherein the software is executable to automatically provide a user who has accessed the GUI to fill out a TFA form of the set of TFA forms with a list of at least one member of a collaboration network associated with the TFA form for collaborating with in filling out the form.

19. The system according to claim 15 wherein the GUI has a home page that provides a view of a plurality of TFA files from which a user may select a TFA file to interact with, the home page configured to display:
a TFA ID card for each of a plurality of TFA deals that the system facilitates, which identifies and displays summary data for the deal;
a responsibility alert radio button (RABUT) that alerts the user to a total number of TFA files from the plurality of TFA file for which the user has a responsibility; and
a header banner having wheel radio buttons each of which wheel radio button is associated with a different TFA ID feature that characterizes TFA deals for which TFA ID cards are displayed on the home page and is partitioned into a plurality of sectors, each sector representing a different particular value that the ID feature may assume;
wherein a sector is selectable to filter the home page display to show only those TFA ID cards that are distinguished by the particular TFA ID value.

20. The system according to claim 19 wherein each wheel radio button identifies a total number of different values the TFA ID feature may assume.

21. The system according to claim 19 wherein each displayed TFA ID card is selectable to cause the GUI to display a menu of selectable action items that the user may select to undertake for the TFA represented by the TFA ID.

22. The system according to claim 19 wherein the menu comprises an action item that causes the GUI to provide a display enabling the user to collaborate with other users to amend data in the file.

23. (canceled)

24. The system according to claim 1 wherein prioritizing comprises prioritizing responsive to a current state of progress toward completion of the TFA of the given TFA type.

25. The system according to claim 1 wherein prioritizing comprises prioritizing responsive to a number and qualifications of the members of the at least one collaboration network.

26. The system according to claim 1 wherein the at least one KPI is weighted by communications bandwidth consumed in processing the TFA or a stage of the TFA.

27. The system according to claim 1 wherein the at least one KPI is weighted by a function of an amount of funding and risk factors associated with the TFA of the given TFA type.
